(19) United States
(12) Patent Application Publication
(10) Pub. No.: US 2006/0056722 A1
(43) Pub. Date: Mar. 16, 2006

(54) Edge preserving method and apparatus for image processing

(76) Inventor: Nathan Moroney, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/941,138

(22) Filed: Sep. 14, 2004

(51) Int. Cl. G06K 9/40

(52) U.S. Cl. 382/266

(57) ABSTRACT

A method and apparatus for edge-preserving processing of digital images includes selecting an input pixel from a digital image, choosing a set of neighboring pixels from an area around the input pixel according to a sparse matrix constructed according to a distribution, determining the similarity in value of each neighboring pixel to that of the input pixel according to a metric, and calculating a weighted average of the values of the neighboring pixels by weighting by a first smaller weight those pixels which are less similar to the input pixel and weighting by a second greater weight those pixels which are more similar to the input pixel.

### BACKGROUND

The present invention relates to digital processing of electronic images. Digital cameras, image scanners, copiers, facsimile machines and other devices capture images as electronic elements or “pixels” in a format suitable for transmission, printing or storage. The pixels can be stored in a raw data format as they are recorded by the electronics and optics of the camera. Alternatively, the pixels from an image can be processed to enhance certain color or image characteristics for immediate viewing or printing without significant further post-image processing. In either case, these pixels are generally represented as numerical intensity values in a target color space associated with a particular output device. These intensity values are often divided into “chrominance” channels and a “luminance” or “grayscale” channel. Luminance can be calculated from the RGB values by converting to a luminance-chrominance type opponent colorspace like YC1C2 (i.e., “Y” for luminance and “C1” and “C2” for the two chrominance channels).

Despite the appearance of accuracy, there is generally some degree of unwanted noise that appears in digitally represented images. For instance, photosensors generate background signal levels and create noise even when no light is received. Additional noise may be caused by thermal or synchronous activity in various electrical elements associated with these photosensors. The limited precision associated with analog-to-digital conversion also causes noise as the transitions in chrominance and luminance appear as “bands” across the image. This banding typically occurs because neighboring pixels tend to transition from one level to another together along a gradient.

In general, the source of noise can be attributed to a variety of causes ranging from sensitivity differences between photosensors to actual manufacturing defects. Conventional digital cameras and scanners have attempted and failed to devise calibration processes that either completely eliminate or significantly reduce the effects of noise and manufacturing variation. Consequently, noise appears as a defect or artifact in the image even after performing current conventional calibration operations.

In addition, conventional image processing routines also do not adequately address the removal of low-contrast variation that often arises in imaging. For example, low-contrast variation in an image can occur as a result of small roundoff errors or other calculation variations introduced during the digital imaging process. Low-contrast variation is a particular issue as the human visual system is very sensitive to changes in intensity even in the darker areas of an image. This follows from the fact that human sensitivity to light intensity is approximately logarithmic.

There have been attempts to address this low-contrast variation through application of various low-pass filters. These low-pass filters carefully blur portions of image to suppress some of the objectionable low-contrast noise or variation while preserving the high-contrast or large scale structure in the image. Low-pass filters work by accommodating the human visual system's decreasing sensitivity to spatial detail in areas of the image having decreasing intensity levels.

The current low-pass filters used in image processing tend to require a great deal of processing power and computations. For example, low-pass filters used for this purpose include uniform, triangular and Gaussian blurring filters. More sophisticated algorithms include robust anisotropic diffusion, bilateral, and multi-scale bilateral filters. As expected, the processing requirements associated with these algorithms are high as computations are performed on each and every pixel in an area of interest. In the case of a histogram, the computations further include weighting a pixel according to its relative frequency of occurrence in an image and then using the weighted result to identify pixels deemed similar to a target pixel. Theoretically, pixel intensities are most similar due to common subject matter the pixels represent in the image.

Unfortunately, the conventional filtering methods not only have extensive computational requirements but are difficult to use. In some instances, these previously described conventional filters further require extensive configuration and customized software routines or even may require post-processing after their application.

Aside from the aforementioned drawbacks, available image processing routines tend to be ineffective at preserving edges in the images they process. The low-pass filters, calibration routines and other image processing operations tend to also introduce “halos” around sudden transitions in the image rather than preserving the actual sharpness or gradient in the original image. Haloing and low-contrast blurring occurs in conventional image processing operations as a result of pixel selection in the image and the method used for their combination. Specifically, conventional image processing algorithms adjust the value of a target pixel based on an averaging or similar computation on an immediately surrounding region of pixels near the target pixel. For instance, if a light pixel is selected as the target pixel and surrounding pixels are dark pixels then the resulting target pixel value will be generally darkened based on the average value of the surrounding pixels. This assumes that the target pixel containing the lighter intensity value is dissimilar to those in the immediate neighborhood due to a measurement error, noise or some other undesired detail. Of course, conventional image processing routines work moderately well when the target pixel is actually dissimilar or eccentric as the neighboring pixel values more properly reflects the original or intended value associated with the target pixel.

However, in very detailed images a large number of the nearby dissimilar pixels are not properly viewed as eccentric but instead represent an important edge or detail in the image such as a transition between a person's face and background sky. The conventional approaches to image processing do not preserve this sharp edge, as the pixel values near the edge are replaced by values offering a compromise between the original pixels on one side of the edge with those that are on the other. This causes a gradual transition between intensities or colors resulting in the aforementioned halo effect rather than the sharp transition characteristic of the original image. The same effect occurring on the sharp edges in the image also occur in the low-contrast areas of the image. Instead of a halo effect, however, the areas of the image containing low-contrast pixel values tend to blur and sometimes disappear as the lack of contrast is also averaged and details are lost.

### BRIEF DESCRIPTION OF THE DRAWINGS

The present invention is illustrated by way of example and not limitation in the figures of the accompanying drawings in which:

FIG. 1 is a schematic diagram showing one embodiment of the present invention that processes a captured image and outputs the results on a printer or display;

FIG. 2A is a schematic diagram illustrating the edge preservation without haloing and low-contrast blurring in accordance with one embodiment of the present invention;

FIG. 2B is a schematic diagram illustrating the low-contrast blurring and haloing of images generated by conventional image processing techniques;

FIG. 3 is a flowchart of operations for processing an image in accordance with one embodiment of the current invention;

FIG. 4A is a schematic diagram illustrating the processing of an input pixel and associated measurement of neighboring pixels in accordance with one embodiment of the present invention;

FIG. 4B is a chart showing a weighting and processing associated with a pixel and neighboring pixels in FIG. 4A in accordance with one embodiment of the present invention; and

FIG. 5 is a diagram of a system designed in accordance with one embodiment of the present invention.

### SUMMARY OF THE INVENTION

One aspect of the present invention describes a method for processing digital images. The method includes selecting an input pixel from a digital image, choosing a set of neighboring pixels from an area around the input pixel according to a sparse matrix designed according to a distribution, determining the similarity in value of each neighboring pixel to that of the input pixel according to a metric, calculating a weighted average of the values of the neighboring pixels by weighting by a first smaller weight those pixels which are less similar to the input pixel and weighting by a second greater weight those pixels which are more similar to the input pixel.

Another aspect of the present invention describes a computer program product for processing digital images. The computer program product includes instructions capable of causing a programmable processor to select an input pixel from a digital image, choose a set of neighboring pixels from an area around the input pixel according to a sparse matrix designed according to a distribution, determine the similarity in value of each neighboring pixel to that of the input pixel according to a metric, calculate a weighted average of the values of the neighboring pixels by weighting by a first smaller weight those pixels which are less similar to the input pixel, and weight by a second greater weight those pixels which are more similar to the input pixel.

### DETAILED DESCRIPTION

Implementations of the present invention are capable of image processing and preserving edges of a digital image. Pixels are selected during the image processing operation of the present invention according to both pixel values and their proximity to a sample pixel of interest in the image. Instead of processing all pixels in the image, embodiments of the present invention first selects a sparse subset of pixels nearest the sample pixel and then perform the weighting calculations on these fewer pixels. The pixel values are weighted and combined in accordance with embodiments of the present invention to achieve the desired image processing effect efficiently and without undesirable “haloing” and other image defects.

Aspects of the present invention are advantageous in at least one or more of the following ways. Image processing using embodiments of the present invention can be done in a computationally efficient manner as not all pixel values in an area of interest are used during the image processing operation. Careful selection of a reduced number of neighboring pixels yields improved performance over image processing operations that perform a complete sampling of neighboring pixels.

The improved computational efficiency facilitates applying embodiments of the present invention to large area filtering types of image processing. The computational efficiency achieved lends to larger arrays or matrices of pixels being sampled and processed in the image without typical loss of detail or degradation of the overall image appearance. These improvements in processing efficiency make different types of image processing operations previously considered too complex available for use.

Yet another aspect of the present invention facilitates edge preservation during image processing. The edge preservation of the present invention avoids introducing haloing and low-contrast blurring into the image by careful selection and combination of pixel values. Image processing routines using embodiments of the present invention can apply their image processing effects without losing edges around sharp transitions and introducing halos or other artifacts.

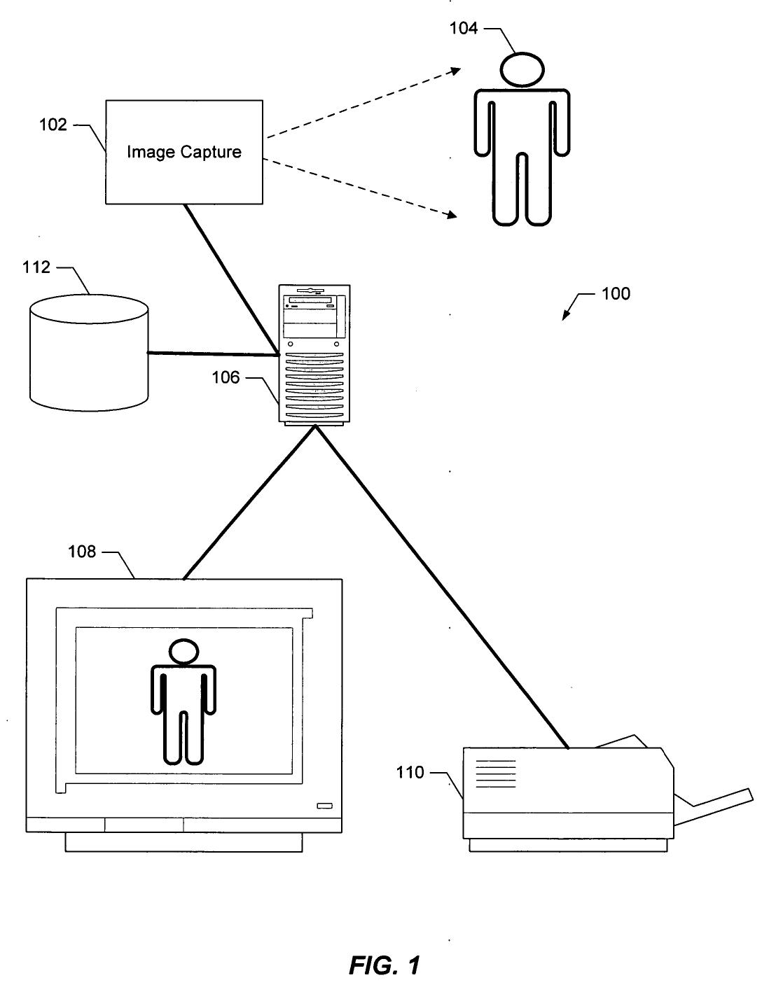

FIG. 1 is a schematic diagram showing an embodiment of the present invention that processes a captured image and outputs the results on a printer or display. An example system 100 includes an image capture device 102, an image 104, an image processing station 106 for processing image 104, a storage 112 for holding image data, a display device 108 and a printer 110. Image 104 is processed and enhanced in accordance with embodiments of the present invention and then output on a printer 110 or display 108.

Image capture device 102 could be a variety of devices used to capture images including a digital camera or a scanner. The digital camera device captures image 104 locally and transmits it either synchronously or at some later time to image processing station 106. Alternatively, a scanner device scans an existing photograph, reproduction or other pre-existing image and also transmits either in real-time or subsequently to image processing station 106. Many other methods of image capture also exist and would be suitable for use in conjunction with various embodiments of the present invention.

Image 104 typically contains noise or artifacts due to the limited precision of analog-to-digital converters used in the image capture process, background signal noise, inherent manufacturing inconsistencies in the image capture device and other noise sources. These artifacts and noises occur in image rendered in either grayscale or the color domain. Accordingly, image processing operations designed in accordance with the present invention target certain types of noise, artifacts or other effects found in rendering image 104 in both the grayscale and color domains; it is not limited to application in one domain or the other.

Image processing station 106 performs image processing on the captured image in accordance with the present invention. Embodiments of the present invention can be implemented as a standalone application or integrated in existing image processing applications as part of the image processing operations already defined in the applications. For example, embodiments of the present invention can be implemented to work with an image processing application or as a plug-in to a web-browser or other applications to enhance the various image processing routines and operations these applications provide.

Storage 112 can be used to store initial image data of image 104 taken by image capture device 102 or intermediate digital versions of image 104 as they are processed by image processing station 106. For example, storage 112 can be removable non-volatile memory (e.g., compact flash, secure digital, smart disk or memory stick), disk, CD, or other memory device used to store one or more images directly as they are taken by image capture device 102. Embodiments of the present invention transfer images to storage 112 from image capture device 102 via a USB cable, wireless network or Ethernet network and then, optionally, store the results in the random access memory (RAM) or hard drive of image processing station 106.

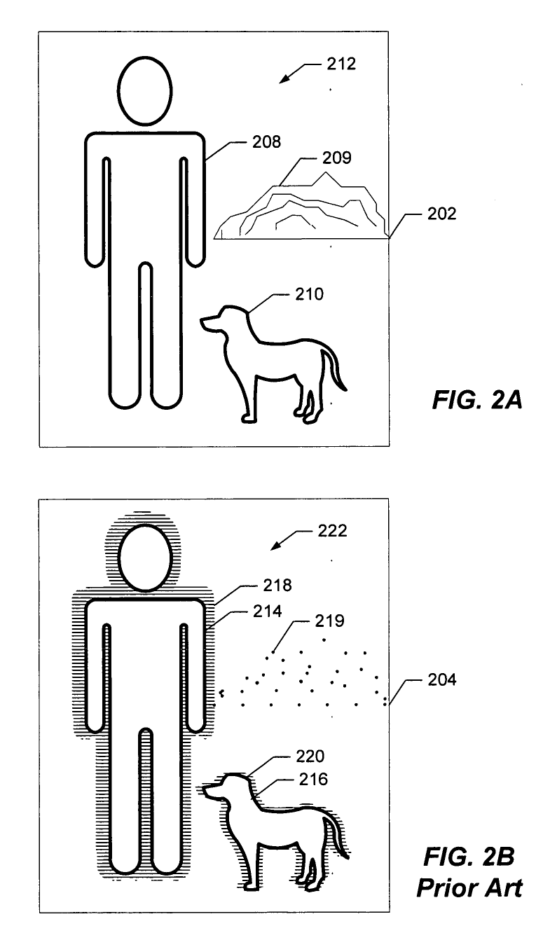

FIG. 2A is a schematic diagram of an image illustrating the edge preservation without haloing or low-contrast blur in accordance with one embodiment of the present invention. In this example, image 202 has region 208 and region 210 against background 212 as examples of sharp contrast while region 209 provides an example of a low-contrast area. Each region is processed by image processing operations implemented using embodiments of the present invention rather than the aforementioned conventional approaches to image processing. Embodiments of the present invention are implemented in an image processing operation that both increases the contrast between regions 208, 209, 210 and background 212 while altering the hue of regions 208, 209, and 210. In addition, embodiments of the present invention operate to simultaneously reduce noise and low-contrast fluctuations in the respective regions. Instead of a halo, processing images in accordance with the present embodiment retains the sharp contrast associated with 208 and 210 against background 212 with crisp transitions and edges as illustrated in FIG. 2A. Further, low-contrast regions like region 209 are preserved throughout the image processing routine rather than being lost due to undesirable low-contrast blurring. As described later herein, the haloing and low-contrast blur is incurred as embodiments of the present invention weight the similar pixels more heavily than dissimilar pixels using a number of factors.

FIG. 2B is a schematic diagram of input and output images illustrating the haloing and low-contrast blurring of images generated by conventional image processing techniques. Regions 214 and 216 against background 222 provide examples of sharp contrast while region 219 provides an example of a low-contrast image. Each region in image 204 is processed by one or more conventional image-processing techniques. For example, one image processing operation is used to increase the contrast between regions 208 and 210 and background 212 while another alters the hue of regions 214 and 216 and attempts to simultaneously reduce the noise and low-contrast fluctuations in the respective regions. Another image processing routine may attempt to sharpen edges in low-contrast region 219. The results of this processing creates image 204 against background 222 with region 214 and 216 surrounded by halos 218 and 220 respectively. Further, the effect of the above image processing on region 219 causes low-contrast blurring and region 219 to all but disappear as illustrated.

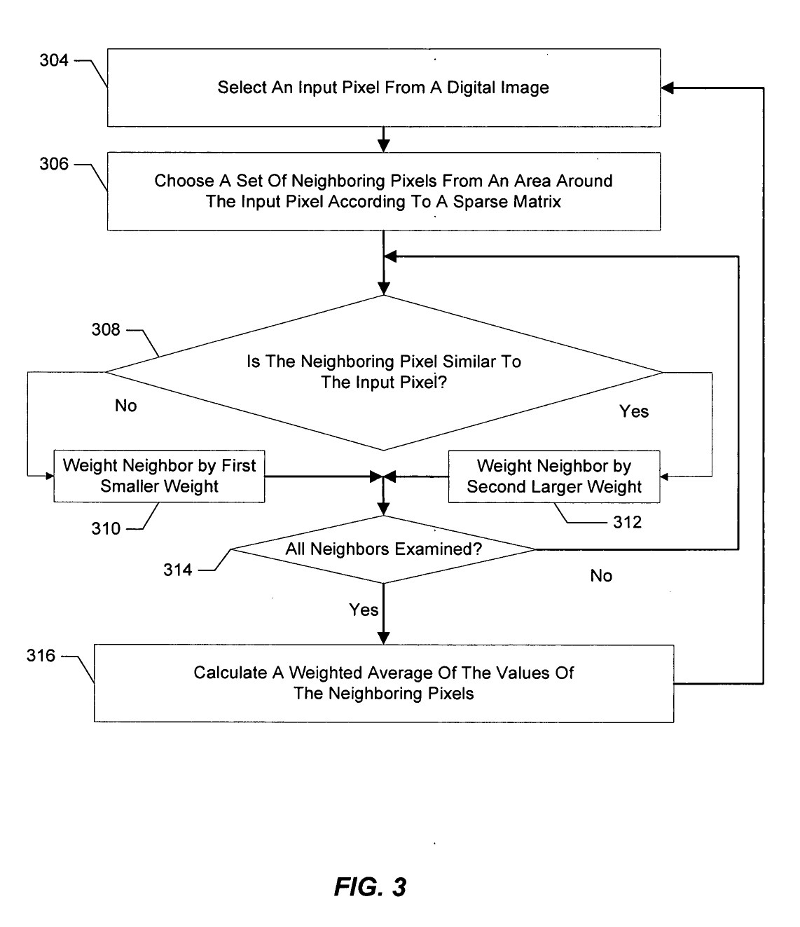

FIG. 3 is a flowchart of the operations for processing an image in accordance with one embodiment of the present invention. In one implementation, processing is performed on a digital image containing noise or low-contrast detail to be removed. The image data can be stored in a data structure or filesystem and can be read off a network, hard drive, or directly from an input device. In an alternative embodiment the image is received from an image generation device such as a camera or scanner and processed “on the fly.” In either embodiment, the received digital image can be of a variety of types, including without limitation GIF, JPEG, BMP, or TIFF.

Initially, the image processing operation selects an input pixel from the digital image (304). The selected input pixel is the target pixel and is modified using neighboring pixels selected from the surrounding area in accordance with embodiments of the present invention. In one embodiment, the input pixel is selected in a predetermined sequence until all the potential input pixels in an entire image or a region of an image until each pixel are processed.

Alternatively, the input pixel and neighboring pixels can be selected for processing depending on a regional characteristic. For instance, a user may desire to apply image processing to a region of low light intensity where image noise is particularly apparent and bothersome. The user could select the region or set of regions by use of a mouse pointer or by describing the nature (e.g., color) of the region he or she wishes to process. The user might also desire to apply color mapping between colors or perform a replacement of colors in one or more particular regions. For instance, the user may desire to convert the color contrast to luminance contrast, or vice versa, for aesthetic purposes.

Next, the image processing operation chooses a set of neighboring pixels from an area around the input pixel (306) according to a “sparse matrix” describing the locations of those pixels. Neighboring pixels are first selected according to the spatial distance from the target pixel without consideration to other characteristics like intensity, chrominance or other feature. By deferring consideration of these features, the first pass of pixel selection can be performed quickly and efficiently with little complex calculations. The pixel selection process is further improved by using a sparse matrix in which most of the elements are zero or unused. In contrast, a full matrix would require analysis of every pixel in the entire neighboring region. The sparse matrix thereby saves on storage requirements and more importantly allows calculations to be made with fewer neighboring pixels.

Selecting the neighboring pixels for this sparse matrix can be performed in either a predetermined or random manner. One embodiment of the present invention randomly selects pixels according to a triangular, Gaussian, Cauchy or other non-uniform distribution. Masks for selecting pixels for the sparse matrix can be calculated and used in advance because the distributions consider a certain area and not specific pixel values. In general, it is desirable to pick a distribution that includes pixels from the underlying image without tracking the exact shape of the pixels in the image. This ensures that a slightly larger, smaller or skewed distribution compared to the underlying image does not effectively miss sampling the underlying image. For example, a hypothetical mask for sampling a region shaped like a letter “O” with a 5 inch diameter would improperly sample and probably miss pixels in an area of the image coincidentally shaped like the letter “O” but containing a 7 inch diameter. Consequently, it is generally better to sample a region of the image using a random set of sample points according to one or more of the above described non-uniform distributions.

These non-uniform distributions are desirable as they increase the likelihood of selecting pixels closer to the input pixel due to the spatial weighting inherent in these distribution patterns. Once again, the resulting sparse matrix emphasizes pixels in the region closer to the input pixel rather than pixels having a similar intensity or other quality. By reducing the sample set initially, fewer calculations are made later when the weighting operations actually occur. In practice, the spatial selection of the pixels for the sparse matrix indirectly increases the “weighting” of nearby pixels as pixels further away may not be selected depending on the non-uniform distribution used. Using the proper distribution affects the likelihood that the fewer pixels selected for the sparse matrix tends to describe the same real-world object and conditions near the input pixel.

By increasing or decreasing the number of neighboring pixels in the sparse matrix the user can modulate the amount of memory or processing power required. One embodiment of the present invention selects the neighboring pixels from a region according to one or more various shapes. For example, the sparse matrix can use a rectangle, square, circle, ovoid or other shapes to select the neighboring pixels from the region. In addition, the user can also adjust the size of the region to modulate the amount of required resources and/or configure a particular embodiment to provide a desired effect. Accordingly, one embodiment of the present invention automatically selects the number of pixels to be used in the sparse matrix by controlling size of the region covered by the sparse matrix. For example, this automatic control of the size of the region can be based on characteristics of the image such as the amount of low-contrast noise detected in the image being processed.

Setting the number of neighboring pixels used in the sparse matrix much lower than the total number of pixels in the surrounding region significantly reduces the amount of computational resources required. For instance, if the neighboring region is 30 pixels by 30 pixels, there will be 30×30−1, or 899 neighboring pixels (1 is subtracted for the target pixel). To conserve computational resources a user can construct a sparse matrix of only 50 pixels that potentially results in as much as an 18-fold speedup.

Next, the image processing operation determines whether each of the neighboring pixels described by the sparse matrix is similar to the input pixel (308). Embodiments of the present invention perform this similarity determination in several computationally efficient ways. First, fewer pixels in the sparse matrix means fewer determination operations are required than conventional solutions that must compare every pixel in a surrounding region. Second, the comparison is performed by subtracting the intensity of a neighboring pixel from the intensity of the input pixel and then comparing the absolute value of the result with a predetermined threshold value. If the absolute value is less than the predetermined threshold then the neighboring pixel is considered similar and if the absolute value is greater than the threshold value then the pixel is considered dissimilar. The computational efficiency of this operation is due in part to the few operations required for a digital computer to perform the subtraction and simplified comparison operations.

An alternative embodiment performs the similarity determination by comparing the chrominance intensity associated with an input pixel with the corresponding chrominance intensity of a neighboring pixel. Instead of using all the luminance or chrominance channels, this approach subtracts one chrominance component of the input pixel from the chrominance component of a neighboring pixel. The absolute difference is compared with a predetermined threshold as previously described to determine whether the two pixels are classified as similar or dissimilar. For example, the similarity determination would subtract the red chrominance of the input pixel from the red chrominance of the neighboring pixel to perform the threshold comparison.

If a neighboring pixel is found to be dissimilar to the input pixel, it is weighted by a first smaller weight (310) and if it is similar to the input pixel, it is weighted by a second larger weight (312). Increasing the weight of more similar pixels results in image processing operations that have more accurate results and fewer artifacts. For example, the previously described halo endemic to conventional image processing routines is effectively eliminated. Further, fewer weighting operations are performed using the elements of the sparse matrix than conventional solutions that weight each and every pixel sampled in a region.

As in the comparison operation, embodiments of the present invention perform the weighting operation of similar and dissimilar pixels in a computationally efficient manner. In one embodiment, the neighboring pixel is selectively multiplied by a first smaller weight set equal to one when the pixel is dissimilar or multiplied by a second larger weight is set equal to a factor of two when the pixels are similar. These computations are efficiently performed on a computer by bit shifting or rotating the neighboring pixel by an appropriate number of word rotations or shifts, which require few processor cycles.

These previously described operations are repeated until all neighboring pixels are examined (314) and the image processing method calculates a weighted average of the values of the neighboring pixels (316) for each input pixel. This average is either stored directly in an output image in place of the input pixel or in an image mask that represents the input pixel values. For example, the image mask can be used later for further image processing for purposes of dynamic range reduction, special gamut mapping or other image processing effects.

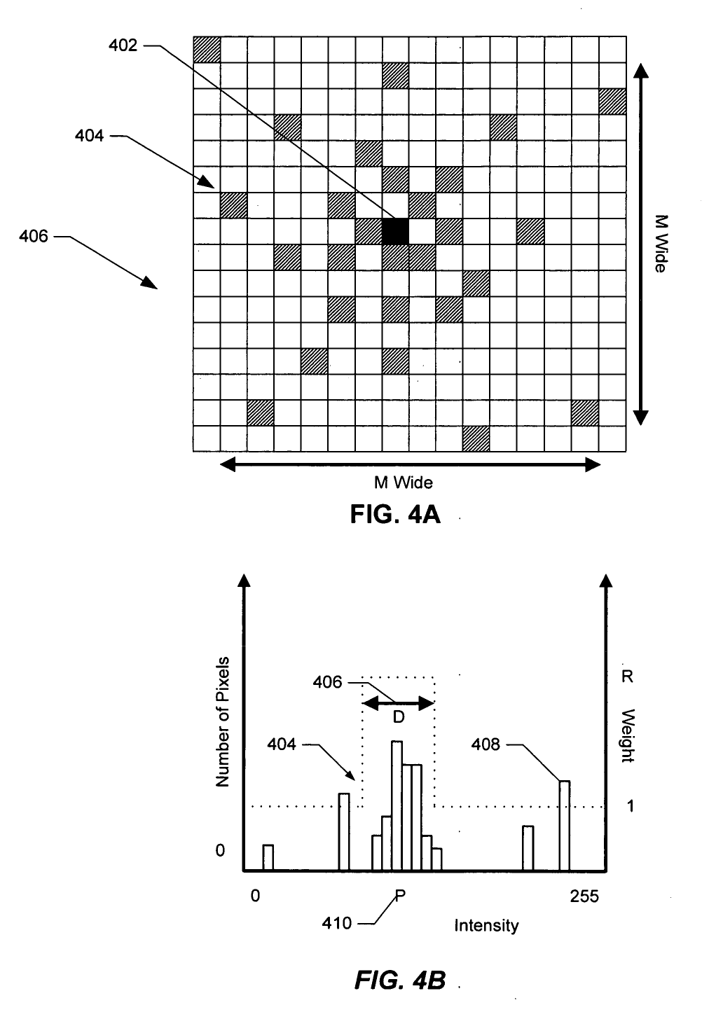

FIG. 4A is a schematic diagram illustrating the processing of an input pixel and associated measurement of neighboring pixels in accordance one embodiment of the present invention. In this example, an input pixel 402 is surrounded by a set of neighboring pixels 404 in a sparse matrix selected from a neighboring M by M region 406. As previously described, one embodiment selects the neighboring pixels using a non-uniform distribution centered on the input pixel and based upon the distance from the input pixel. This particular sparse matrix used a Gaussian distribution to select pixels in spatial proximity of input pixel 402. This results in a sparse matrix containing a greater number of pixels closer to the input pixel. The sparse matrix locations can be computed in advance for a given M×M region 406 as the first pass of this process does not consider intensity or other characteristics of the pixel values initially. Many different sparse matrices can be computed in advance for different region sizes and image types and then selected during the image processing operation.

This non-uniform distribution effectively weights the pixels in nearby regions more heavily by selecting closer pixels more often. In this example illustration, the different shadings are meant to distinguish the pixels and do not represent the actual intensity values of the pixels. After selection of the neighboring pixels, the image processing operations compares each neighbor pixel to the input pixel as described above to determine the similarity or dissimilarity. In one embodiment, the intensity of each neighboring pixel is then subtracted from that of the input pixel. If the absolute value of the difference is less than a threshold D, the neighboring pixel in question is given a greater weight otherwise it is given the weight 1 or other smaller weight value.

FIG. 4B is a bar chart showing the possible results of a comparison of neighboring pixels with an input pixel (P). Bar chart in FIG. 4B includes a dotted line 404 graphing the weighting applied to pixels found to be similar or dissimilar in accordance with embodiments of the present invention. Dotted line 404 further includes a horizontal bar 406 indicating the threshold D; vertical bars 408 representing the number of neighboring pixels having an intensity, from 0 to 255; and a label P 410 indicates the intensity of the input pixel on the same 0 to 255 scale.

The vertical axis in FIG. 4B represents two quantities corresponding to the right and left vertical scales. Accordingly, the number of pixels is indicated by the left vertical scale (i.e., “Number of Pixels”) and corresponds to the height of vertical bars 406 while the “Weight” scale on the right side of the graph indicates the weighting to be applied along dotted line 404.

In this example, the dotted line representing the weight undergoes two sharp transitions. The first transition occurs from 1 to R when the digital count approaches the threshold D from the left of the value of P and again from R to 1 when the digital count exceeds the threshold on the right side of the value of P. These vertical bars 408 illustrated in FIG. 4B indicate in this example that the neighboring pixels selected based on spatial distance also tend to be similar in value to the intensity of the input pixel.

However, there are also several peaks further from that intensity shared by the neighboring pixels and the input pixel 410. Peak 408 illustrated in this example exists if more than one or a different edge existed in the image near the input pixel. The additional edge or boundary might be between a white shoe against a dark background grass. Embodiments of the present invention recognize that peak 408 likely represents another edge and does not use the value in these calculations. This keeps a halo from being treated around an object like a white shoe against the sharp contrast of the grass around the white shoe. Unlike conventional image processing, embodiments of the present invention would not heavily factor in the whiteness of the shoe in the processing of pixels representing nearby grass thereby avoiding haloing or other deleterious effects. Instead, embodiments of the present invention place a greater weight on similar and spatially nearby pixels as these nearby pixels are more likely to represent similar components of the image.

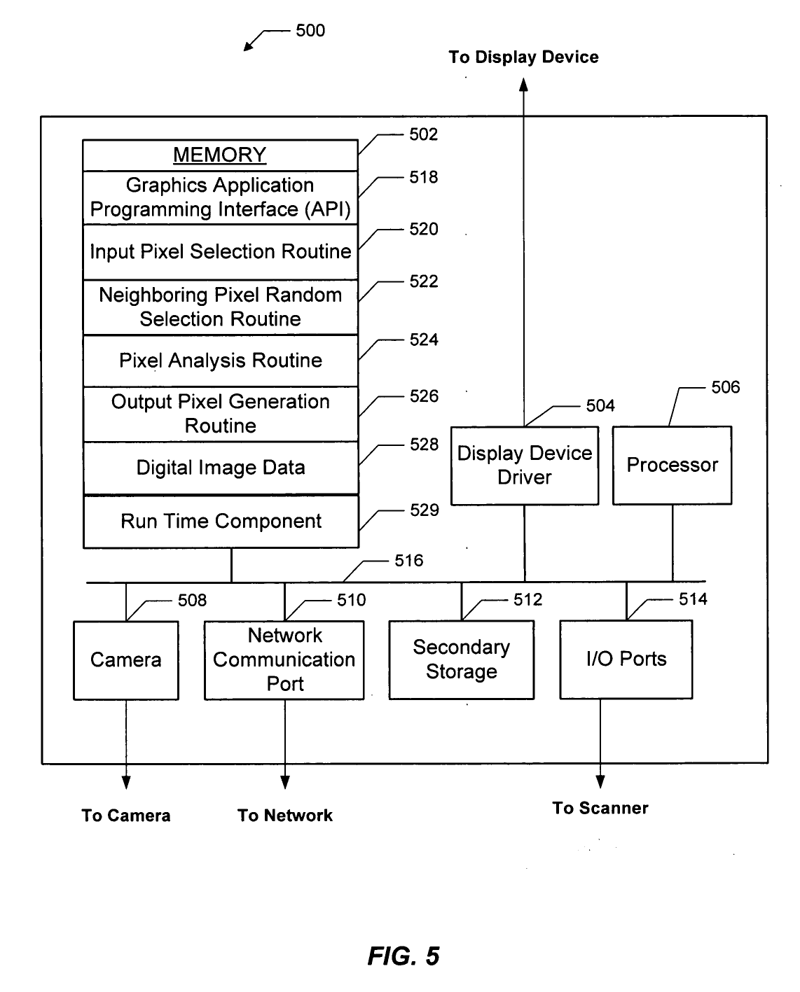

FIG. 5 is a diagram of a system 500 designed in accordance with one embodiment of the present invention. System 500 includes a memory 502 to hold executing programs (typically random access memory (RAM) or read-only memory (ROM) such as a flash ROM), a display device driver 504 capable of interfacing and driving a display device or output device, a processor 506, a camera 508, a network communication port 510 for data communication, a secondary storage 512 with a secondary storage controller and input/output (I/O) ports and controller 514 operatively coupled together over an interconnect 516. System 500 can be preprogrammed, in ROM, for example, using field-programmable gate array (FPGA) technology or it can be programmed (and reprogrammed) by loading a program from another source (for example, from a floppy disk, a CD-ROM, or another computer). Also, system 500 can be implemented using customized application specific integrated circuits (ASICs).

In one embodiment, memory 502 holds a graphics application programming interface (API) 518, an input pixel selection routine 520, a neighboring pixel random selection routine 522, a pixel analysis routine 524, an output pixel generation routine 526, digital image data 528, and a run-time component 529 for managing resources on system 500.

The systems commonly used to implement graphics processing techniques include workstations and consumer PCs, but the invention described herein is not limited to any particular implementation. Indeed the apparatus and methods described here can be embedded directly into an image capture device such as a camera or scanner. Accordingly, system 500 is only one embodiment and should not be read to describe only graphics workstations. The camera, network communications port, secondary storage, and I/O ports may or not be present and are not needed for the functioning of some embodiments.

API 518 mediates between the routines in memory and a programming language or image processing application. Various graphics applications can be integrated and combined with graphics API 518 for performing various embodiments of the present invention. For example, Adobe Photoshop, marketed either by Adobe Systems, Inc. and other graphics applications can interface to embodiments of the present invention through graphics API 518.

Pixel selection routine 520 selects an input pixel from an image to be processed by embodiments of the present invention. In one embodiment, pixel selection routine 520 begins processing the input pixel at one corner of a rectangular image and scans across rows of pixels until the entire image has been processed iteratively. Alternatively, selection routine 520 scans through a selected region of the image specified by the user or an application rather than the complete image. In another embodiment, selection routine 520 scans for regions with low illumination, contrast or other regional characteristics in the image where image processing is deemed particularly beneficial.

Neighboring pixel selection routine 522 selects the neighboring pixels according to the sparse matrices in accordance with implementations of the present invention. For example, neighboring pixel random selection routine 522 can apply one or more pre-existing sparse matrices of neighboring pixels to different input pixels during image processing. These sparse matrices can be identified using predetermined filters calculated in advance for different matrix sizes and aspect ratios. Alternatively, an efficiently calculated non-uniform random distribution could also be computed for each input pixel and used to create the sparse matrix dynamically.

Pixel analysis routine 524 is determined largely by the particular image processing being performed. A simple edge-preserving low-pass filter can be implemented by determining similarity of the input pixel and neighboring pixels according to luminosity. However, other embodiments can perform other image processing techniques. For instance, the pixel analysis routine might compare input and neighboring pixels based on hue, chromacity, saturation, or a single color component.

Output pixel generation routine 526 computes the output pixel based on the values of the neighboring pixels and the comparisons by the pixel analysis routine. In the case of a low-pass edge-preserving filter, the pixel generation routine creates a weighted average of the luminance, as described previously. These output pixel results could also be used to generate an image mask. One use of such a mask is as a color mask; another is the use of the mask plus a tone reproduction surface for more aggressive adjustments, such as those that might be required for scene rendering.

Because of the edge-preserving quality of the apparatus, it is well-suited as a swath or block-based image processing operation that acts as an edge-preserving low-pass filter. Embodiments of the present invention can be configured to suppress low-contrast regions of an image in an efficient manner. These lower-contrast regions can be either image structure or noise. The resulting image can be used for other image processing, such as dynamic range reduction or spatial gamut mapping.

Color masks are also useful for selective color manipulation, such as might be appropriate for spatial gamut mapping. Local color-correction techniques have numerous advantages. For instance, local correction can simultaneously lighten shadows and darken highlights by using a simple pixel-wise “gamma” correction of the input data. Also, some embodiments balance global and local contrast changes and reduce chromacity distortions by using an inverted, low-pass filtered, monochrome version of the original image as the tone mask.

Moreover, performing the local color correction using an embodiment described here is simple and fast. A significant improvement in image quality relative to a global correction is achieved. There is no need to rely on complicated visual models or masks.

Some embodiments are enhanced for processing speed using look-up-tables. Fine tuning can be achieved by using a continuous function for similarity weighting. Sparse spatial sampling could also be designed based on desired power-spectrum properties, such as those used for an FM halftone screen.

Although embodiments of the present invention were described in connection with a tone mask operation for modifying input pixel values, it is not so limited. More generally, the input pixel values may be locally modified according to local pixel neighborhoods. The pixel values may be locally modified by operations such as, without limitation, blurring, decimating, and median filtering. The tone mask is only one example.

The invention is not limited to the specific embodiments described above. For instance, the invention is not limited to a single monochrome mask for modifying pixel values for all component colors. Separate masks for each component color may be used instead. Each of the masks can be optimized for its component color value.

Embodiments of the invention can be implemented in digital electronic circuitry, or in computer hardware, firmware, software, or in combinations of them. Apparatus of the invention can be implemented in a computer program product tangibly embodied in a machine-readable storage device for execution by a programmable processor; and method steps of the invention can be performed by a programmable processor executing a program of instructions to perform functions of the invention by operating on input data and generating output. The invention can be implemented advantageously in one or more computer programs that are executable on a programmable system including at least one programmable processor coupled to receive data and instructions from, and to transmit data and instructions to, a data storage system, at least one input device, and at least one output device. Each computer program can be implemented in a high-level procedural or object-oriented programming language, or in assembly or machine language if desired; and in any case, the language can be a compiled or interpreted language. Suitable processors include, by way of example, both general and special purpose microprocessors. Generally, a processor will receive instructions and data from a read-only memory and/or a random access memory. Generally, a computer will include one or more mass storage devices for storing data files; such devices include magnetic disks, such as internal hard disks and removable disks; magneto-optical disks; and optical disks. Storage devices suitable for tangibly embodying computer program instructions and data include all forms of non-volatile memory, including by way of example semiconductor memory devices, such as EPROM, EEPROM, and flash memory devices; magnetic disks such as internal hard disks and removable disks; magneto-optical disks; and CD-ROM disks. Any of the foregoing can be supplemented by, or incorporated in, ASICs.

Thus, the invention is not limited to the specific embodiments described and illustrated above. For example, pixel intensity is one measure used to compare the similarity of pixels however any digital count associated with a pixel characteristic can be used when comparing pixels for similarity or dissimilarity. Accordingly, the invention is not limited to the above-described implementations, but instead is defined by the appended claims in light of their full scope of equivalents.

What is claimed is:

1. A method for edge-preserving processing of digital images comprising:
selecting an input pixel from a digital image;
choosing a set of neighboring pixels from an area around the input pixel according to a sparse matrix constructed according to a distribution;
determining the similarity in value of each neighboring pixel to that of the input pixel according to a metric; and
calculating a weighted average of the values of the neighboring pixels by weighting by a first smaller weight those pixels which are less similar to the input pixel and weighting by a second greater weight those pixels which are more similar to the input pixel.

2. The method of claim 1 further comprising performing image processing on the input pixel based on the weighted average.

3. The method of claim 1, wherein the receiving comprises receiving an image in a format selected from a set of formats including: GIF, JPEG, BMP, and TIFF.

4. The method of claim 1, wherein the receiving comprises receiving an image from a mechanism selected from a set of mechanisms including: a computer file, a digital camera, and a scanner.

5. The method of claim 1, further comprising scanning through all the pixels in a region of an image and selecting each as the input pixel, whereby image processing is performed on the entire region.

6. The method of claim 1, wherein the sparse matrix is constructed according to a random distribution of pixels.

7. The method of claim 6, wherein the random distribution is a non-uniform distribution of pixels with greater likelihood of selecting pixels closer to the input pixel.

8. The method of claim 7, wherein the non-uniform distribution is selected from a set of non-uniform distributions of pixels including: a triangular distribution, and a Gaussian distribution.

9. The method of claim 1, wherein the area around the input pixel is selected from a set of areas including: the interior of a circle, the interior of a square, the interior of an ovoid shape, and the interior of a rectangle.

10. The method of claim 1, wherein the size of the area can be varied based on an input.

11. The method of claim 1, wherein the size of the area is determined automatically in order to accomplish a certain image processing result.

12. The method of claim 1, wherein the metric of determining the similarity in value of pixels is a calculation based on one or more descriptions of the pixels in the image selected from a set of descriptions including: an absolute luminosity of the pixels, a color balance of the pixels, and the intensity of a particular color element.

13. The method of claim 1, wherein the first smaller weight is set equal to unity.

14. The method of claim 1, wherein the first, smaller weight and second, greater weight vary based on one or more inputs.

15. The method of claim 1, wherein the first, smaller weight and second, greater weight are calculated automatically based on the characteristics of a region of an image.

16. The method of claim 1, wherein the image processing is selected from a set of types of image processing including: dynamic range reduction, noise reduction, and spatial gamut mapping.

17. A computer program product for image processing, tangibly stored on a computer-readable medium, comprising instructions operable to cause a programmable processor to:
select an input pixel from a digital image;
choose a set of neighboring pixels from an area around the input pixel according to a sparse matrix constructed according to a distribution;
determine the similarity in value of each neighboring pixel to that of the input pixel according to a metric; and
calculate a weighted average of the values of the neighboring pixels by weighting by a first smaller weight those pixels which are less similar to the input pixel and weighting by a second greater weight those pixels which are more similar to the input pixel.

18. The computer program product of claim 17 further comprising instructions that perform image processing on the input pixel based on the weighted average.

19. The computer program product of claim 17, further comprising a loop routine for scanning through all the pixels in a region of an image and selecting each as the input pixel, whereby image processing is performed on the entire region.

20. The computer program product of claim 17, further comprising constructing the sparse matrix according to a random distribution of pixels.

21. The computer program product of claim 20, wherein the random distribution is a non-uniform distribution with greater likelihood of selection closer to the input pixel.

22. The computer program product of claim 21, wherein the non-uniform distribution is selected from a set of non-uniform distributions of pixels including: a triangular distribution, and a Gaussian distribution.

23. The computer program product of claim 17, wherein the metric of determining the similarity in value of pixels is a calculation based on one or more descriptions of the pixels in the image selected from a set of descriptions including: an absolute luminosity of the pixels, a color balance of the pixels, and the intensity of a particular color element.

24. A computer apparatus for processing digital images comprising:
means for selecting an input pixel from a digital image;
means for choosing a set of neighboring pixels from an area around the input pixel according to a sparse matrix constructed according to a distribution of pixels;
means for determining the similarity in value of each neighboring pixel to that of the input pixel according to a metric;
means for calculating a weighted average of the values of the neighboring pixels by weighting by a first smaller weight those pixels which are less similar to the input pixel and weighting by a second greater weight those pixels which are more similar to the input pixel.
